(19) United States
(12) Patent Application Publication
(10) Pub. No.: US 2011/0071865 A1
(43) Pub. Date: Mar. 24, 2011

(54) CONCIERGE SYSTEMS AND METHODS

(76) Inventors: Alice Leeds, Avon, CO (US); John Pankey, Round Rock, TX (US); Michael Hawthorne, Vail, CO (US)

(21) Appl. No.: 12/724,427

(22) Filed: Mar. 16, 2010

(30) Foreign Application Priority Data
May 4, 2009 (TW) 098114884

(51) Int. Cl. G06Q 10/00; G06F 17/30

(52) U.S. Cl. 705/6; 707/722; 707/E17.014

(57) ABSTRACT

Systems and methods are disclosed for a computer implemented concierge system. The system includes receiving an itinerary having one or more guest interests indicated therein; receiving one or more vendor features or capabilities; filtering candidate trips by matching the guest interests with the vendor features; and displaying the filtered candidate trips for selection.

The invention relates to a communications system and method, and more particularly to a system and method for providing concierge services.

### BACKGROUND

Concierge services are typically provided by hotels. Conventionally, a hotel guest, using the hotel room telephone, places a call to the hotel reception and asks to speak to the hotel concierge. The guest is connected to the concierge who then listens to the request of the hotel guest, such as a request for a restaurant reservation, and notes any preferences, such as the guest's preference for outdoor dining. The concierge then suggests a service, an event or restaurant in accordance with the guest's desires and preferences. The suggestion is often based on the concierge's personal knowledge in the field, and/or by consulting a listing book or directory. Should the suggestion be satisfactory, the concierge will make the necessary reservations and inform the hotel guest of the reservation details.

Concierge services are especially useful for a visitor who is unfamiliar with an area's services, eating establishments or upcoming events. The problem with such a service is that it is restricted to the guests at a specific hotel only. The concierge's suggestions, for practical purposes, can also often be biased, erratic or based on limited listing or directory information. In addition to the above, the hotel guest may also need to write down the reservation details, obtain directions and arrange transportation.

Furthermore, the whole process can be slow, as access to large listings is often manually searched by the concierge. The concierge may also be limited by the type of search he/she can perform. He/She may not be able to search for multiple preferences simultaneously, such as for example an outdoor, non-smoking, vegetarian restaurant, in a specific area. In addition, the concierge may only be familiar with restaurants in a particular area and therefore may be of little use to a hotel guest who is departing that day for another city.

U.S. Pat. No. 7,412,042 discloses information assistance for a concierge-type service, whereby the user may make restaurant reservations, purchase goods and services, obtain movie listings, etc. with an agent's (or operator's) assistance. In accordance with the invention, the agent may suggest a vendor for providing the goods or services requested by the user, and attempt to fulfill the user request. The suggested vendor may be one of the preferred vendors pre-selected by the user; it may be one of the preferred vendors pre-selected by a group to which the user belongs; it may be one of the preferred vendors pre-selected by the provider of the concierge-type service; and it may be one of the preferred vendors pre-selected by a telephone carrier to which the user subscribes. The suggested vendor may also be a function of characteristics of the vendors that the user prefers, costs, etc. The system of the '042 patent resolves conflicts of preferences of different parties involved to come up with a suggested vendor.

Traditionally, concierge and guest service employees of hotels or hospitality companies have been providing assistance to travelers to recommend, place reservations, and confirm activity, transportation, spa, dining, and all of the myriad of services that vendors offer to destination guests, the concierge industry is still using manual methods of booking vendors. The concierge industry is still very much ad hoc and chaotic. Rarely do procedures exist between destinations, hotels, and in many cases, between employees of the same hotel. One takes notes on stick-it pads, the other may have a pad of paper. Having the ability to retrieve history of guest activities for the benefit of repeat guests is a one in a hundred chance. Usually a call is placed to the vendor by the concierge, and the concierge may or may not have all the information necessary to book a particular service.

In all parts of the globe, a concierge or guest service employee does the following three steps:
1) Talk to the guest, understand what they want to do
2) Hang up with the guest and now call all of the vendors to try to reserve what the guests want, and
3) Call the guest back to verbally confirm or if the guest is lucky, receive an emailed or mailed confirmation.

For any hotel who is willing to invest money and manpower hours to automate by either purchasing existing software available to the industry, or building internal guest service systems (i.e. a large hotel chain), the result continues to be the same: hotel employees must first learn the region, learn the vendors, learn the restaurants, and then enter the information into a database.

In addition, the objectivity is lost by concierges and hotel staff demanding high commissions or kickbacks from the vendors. As a result, the guest does not always receive the appropriate vendor for their request. The top priority for the guest to receive the highest quality vendor for their dollars spent is overshadowed by the hotel employees blackmailing the vendors for cash under the table. For all of these years, hotel management has looked the other way as it allows the hotel to pay guest service employees a lower hourly wage, thus reducing their overhead.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 is a block diagram illustrating a distributed computer system to provide concierge services.

FIG. 2 shows an exemplary block diagram of a concierge application called “Add-A-Concierge” (AAC).

FIG. 3 shows an exemplary property module.

FIG. 4 shows an exemplary itinerary builder module.

FIG. 5 shows an exemplary vendor module.

FIG. 6 shows an exemplary administration module.

FIGS. 7A-7Q show exemplary user interfaces for the concierge system.

FIG. 8 shows an exemplary reservation process.

FIG. 9 shows an exemplary available service or product filtering process.

### SUMMARY

In one aspect, a computer implemented concierge system for a hospitality company operates by receiving an itinerary having one or more guest interests indicated therein, wherein each interest has different combinations of guests from a group, as not every guest wants to participate in every service that is booked; receiving one or more vendor capabilities from a vendor database, as each vendor can login and control their own detailed content including descriptions, times, menus, minimum ages, cancellation policies, and required experience levels; matching the guest interests with the vendor capabilities; after verbally or in writing confirming guest interests, clicking a submit button to send communications to a plurality of vendors instantly through an internal email notification system; receiving separate vendor confirmation for each guest interest combined on one chronological itinerary, including details for contact, what to bring and wear, service descriptions, times, minimum ages, cancellation policies; and communicating vendor confirmation with the hospitality company guest service employee to follow up with the guest and saving a history of guest activities to assist guests efficiently on another visit.

In another aspect, a method to operate a computer implemented concierge system includes receiving an itinerary having one or more guest interests indicated therein; receiving one or more vendor capabilities; filtering candidate trips by matching the guest interests with the vendor capabilities; and displaying the filtered candidate trips for selection.

In yet another aspect, a computer implemented concierge system for a hospitality company includes means for receiving an itinerary having one or more guest interests indicated therein; means for receiving one or more vendor capabilities from a vendor database; means for filtering candidate trips by matching the guest interests with the vendor capabilities; and displaying the filtered candidate trips for selection; means for matching the guest interests with the vendor capabilities; means for communicating the guest interests in one parallel transmission to all vendors matching the interests; means for receiving separate vendor confirmation for each guest interest; and means for communicating vendor confirmation with the hospitality company.

Implementations of the above aspect may include one or more of the following. The method includes sending an email or instant messaging to the vendor to notify the vendor of a communication. The system can prompt the hospitality company guest service employee to request information from the guest that the vendor requires. The system can receive a confirmation or an update from the vendor on a predetermined guest interest. The system can notify the hospitality company of the vendor update with an email. The guest can be notified of trip status in an email or on-line message. A filter can be used for showing guest specific activity options or restaurant options. The filter can be by date, time, age, or location. The system can automatically recommend meal plans based on a dietary profile. The system can also automatically generate a local transportation recommendation for the guest interest based on a guest profile. The system can notify a user such as an employee or a vendor of activities on a particular activity or trip, and the vendor or an employee of the hospitality company can log-into a secured server to access all information relating to a guest activity.

Other implementations of the system can also include one or more of the following. The system enables Revenue Sharing in the network with members. In one embodiment, for each service booked by the hotel through the system, the system will receive a commission from the vendor. The system in turn shares a portion of each commission received with the hotel on a monthly basis. The system provides to Executive Level Hotel Management a real-time Gross Revenue Report which reports the revenue of services booked for each vendor by each user password. At the bottom of the report is the total amount of revenue share earned by the hotel for the date range requested by the hotel under the Report Controls, offered on the left side of the report screen.

The system provides a status of reservation page that displays (in different filterable configurations) the status of requested, modified, approved, canceled, or denied requests. This allows the user to monitor, in real time, the status of all reservation requests so that it can be determined whether or not there is any follow up necessary. The system supports filtering of requested services by date, time, age, cuisine, and/or location. This allows the user to find available services that are specific to the requests of the guest. Sources such as Expedia use filtering for large-scale items like lodging, rental cars, and airline tickets. However, these sources do not offer filtering and reservations for local services such as snowmobiling, guided hiking/biking/snowshoe tours, photography trips, surf/scuba lessons, and many other strong local attractions which make guests want to book a trip to that destination.

The system takes the reservation request(s) entered into the itinerary by the guest service employee and contacts the vendors via email for request confirmations. This saves the user time from calling each vendor to book services. The system includes prompting the guest service employee to ask questions that pertain to information needed for a particular service. For example, if a snowmobile tour includes lunch, the system will prompt the hotel employee to ask for dietary restrictions. This prevents the hotel service employee from having to remember (or be trained) what questions to ask, and when, in order to complete a reservation request. Visit profile information, once filled in, carries over into each service selected. This eliminates the time necessary to enter the same information for different services (for example, names and ages). When a service is selected, each individual guest can then be chosen to participate or not participate in that service. Status feature can be shown on the Review Itinerary Page. The user can click on the “Review and Submit” Tab to see on one screen, all of the information entered for that guest's itinerary. Should the user leave the status of each service/dining reservation request as is, all requests will be submitted to each vendor/restaurant. Should the user choose to change the status of any service/dining request, the user can simply click on one of three options:

a. “Include checkbox”: By clicking on this check box, the user can choose to not include the reservation request at the present time. All other requests will be submitted to the appropriate vendor/restaurant. Only those that are unchecked will be excluded from submission.

b. “Edit” icon will return the user to the specific page where the original reservation request was developed. There the user can continue to make edits and click the “Add” button to save the new information. By then clicking the “Review and Submit” Tab, the user can continue with submitting the service/restaurant requests.

c. “Delete” icon will delete that specific service/dining request and it will no longer be saved to the Guest's Itinerary.

A vendor interface can be provided where vendors can login and enter/edit/view their service descriptions. The vendor interface where vendors can login and view/confirm/deny/modify their reservation requests. Auto-confirmations can be generated: when the vendor confirms an activity, the guest service employee is notified and the itinerary is automatically emailed to the guest. The guest service employee does not have to create and email a confirmation. The system can indicate sold-out services after filtering. Vendors can enter if a particular date and time is sold out, so guest service employees do not take the time to offer and request that service for the guest.

Advantages of the preferred embodiments may include one or more of the following. The system is convenient to use. The system provides is a cost-effective Web based system that enables hospitality companies and hotels to deliver superior service to guests without having to overstaff. By enabling regular employees to substitute for expert concierge, the system empowers any hospitality organization with the ability to right-staff. All information is available with a few clicks. The system guides the user to offer guests with the right experience by filtering options to relevant choices. Once the guest selects his/her choices, at the click, all selected vendors are electronically contacted at once, thus saving the hotel employees of the need to individually and manually contact each vendor and make individual reservations over the phone.

Hospitality companies can also take advantage of the solution to cross-sell and up-sell their services by monitoring the information that guests receive. If a guest is interested in having seafood for dinner, for example, the system can show hotel employees and guest photos, descriptions, and menu prices of the seafood dishes available at the hotel's restaurant. The system combines the benefits of face-to-face customer relationships with the most current information available. The solution helps to deliver an unparalleled level of service in a cost-effective, innovative solution. The system enhances the relationships hospitality operators build with guests—and those relationships are built on superior service.

Other advantages of the preferred embodiment may include one or more of the following. The system automates the communications between the guest service employees, the vendors and restaurants, and the guests. In one embodiment, the automation saves at least 30% of the employee's time with each guest itinerary, allowing employees to service a greater number of guests comprehensively, efficiently, and ethically.

The system brings to the forefront the hotel's high priority of providing the guest the best experience possible based on the services that each vendor provides, and taking in to account their reliability, integrity, and what they offer to the guest as part of a memorable destination experience. The system accomplishes this by allowing the vendor to have their own secure interface in to the system to accurately input the details of their services. In turn, hotel management has control over the vendors that appear on their system. For example, if a vendor is in a region with a certain number of hotels that use this system, and one hotel does not want to use that particular vendor, the system allows that vendor to be blocked from that one hotel, while still appearing in the remaining hotels.

The system uniquely allows ANY employee of any hotel in any region to easily use the system as it is designed with clean, intuitive, easy to use screens—without any need to add redundant guest information.

The business model of the system brings ethical and uniformed commissions paid by the vendors only for services booked to the company. This eliminates vendors having to bribe guest service employees with higher commissions than their competitors pay. The company shares with the hotel a portion of the commission paid for each service, thus generating a revenue flow for a department which a hotel rarely receives.

The concierge system performs tasks that save time and money. They organize and schedule and resolve the problems that continue to exist in the industry. The software reduces the need on the hotel employee to enter all of the information and thus is efficient and not reliant on employees' efforts to keep them up to date.

This system takes any destination location and consolidates all the services, accurately input by the vendors themselves in real-time, available to the guest so any hotel employee can become a trained concierge ready to serve guests and clientele.

The system can also prompt the hotel employee to collect information from the guests if the vendor requests. This can be very important when it comes to collecting information on food allergies, ages of children, and ability levels of participating guests.

### DESCRIPTION

Methods, systems, user interfaces, and other aspects of the invention are described. Reference will be made to certain embodiments, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments, a concierge support system for personnel is provided to hospitality businesses as a cost-effective solution that can be offered as a value added service to customers of those businesses. Examples of such business concerns include those in the hospitality and travel industry, as well as convention planners. Such a virtual concierge not only enhances the existing services that the business concern can provide to its clientele but can be a source of revenue for the business concern rather than a cost center.

Applicants use the term “concierge” services as processes and services relating to processing or handling of requested personal arrangements and reservations and providing customer-specific information to meet individual needs rendered together in a hotel. The concierge services for others can include making requested personal arrangements and reservations, running errands and providing customer specific information to meet individual needs, all rendered in business establishments, office buildings, hotels, residential complexes and homes. In one implementation, the concierge services enable employees of hotel members to efficiently place and track reservations for hotel guests. The concierge system enables hotels which may or may not have an online reservation system (and therefore require time consuming phone calls to place reservations and then confirm them with guests) to have computerized reserving services that are local to vacation destinations. In contrast to popular travel web sites such as Expedia which reserves flights, rental cars, and hotels, the system can reserve local services that do not have large online booking engines and make the destination vacation worthwhile such as lessons for skiing, scuba diving, and surfing; tours for hiking, biking, snowmobiling, and snowshoeing; rafting trips, jeep tours, hot air ballooning, helicopter tours, among others. Vendors are linked into the system and enter their service information for the concierges to book. Concierges find these services through filtering features in the system, and can then request multiple reservations from multiple vendors with one click, saving time and increasing their efficiency so they can assist more guests. The system also confirms the reservations via email (in writing), so pricing, times, dates, service descriptions, and cancellation policies are always known to avoid confusion on the part of the guest. After the services are completed and paid, the system shares commission earned with hotel members as a new source of revenue for them.

After the guests have finalized their trip plans, the system sends confirmation requests to vendors in substantially one parallel transmission or in a series of immediate sequential transmissions that are part of one transmission sequence. This parallel approach is advantageous, convenient, and efficient in comparison with the traditional concierge approach which queries vendors by phone for confirmation, one vendor at a time.

According to certain embodiments, the automated front-end concierge system provides access to a web based computer application that allows personnel to select a class of concierge service, specify destination information, total trip time including travel time compared to the inaccurate industry standard of just using the time of the tour, receive pricing information and further allows the customer to pay for the concierge service using a convenient form of payment such as credit card, ability to select to reserve or save and not reserve for a future submission. For example, the automated concierge system also allows the service personnel to check for availability of activities such as outdoor trips or sightseeing trips, dining, and transportation, among others. According to one aspect of certain embodiments, the automated self-service front-end concierge system provides a graphical user interface to allow the agent to input concierge and payment information. According to another aspect of certain embodiments, the automated self-service front-end concierge system creates a trip plan based on the information that the user inputted into the system using the graphical user interface.

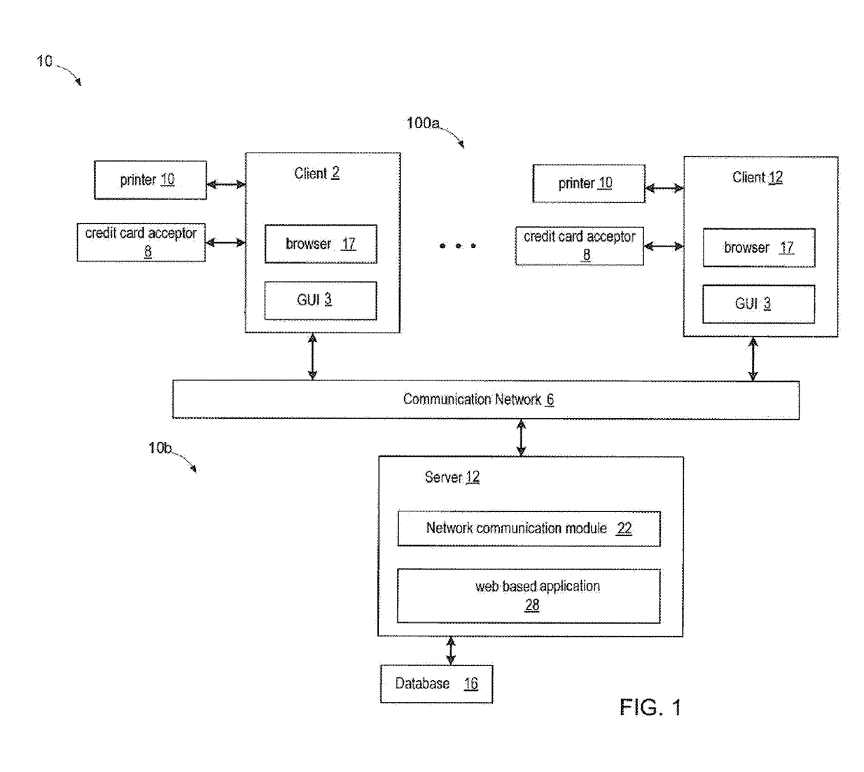

FIG. 1 is a block diagram illustrating a distributed computer system 10, according to certain embodiments. According to some embodiments, automated concierge system 10 may include one or more client computers 2, output devices 10 (e.g., printer), input devices (not shown) and may optionally include a credit card acceptor machine 8.

According to certain embodiments, the system 10 may include one or more distributed servers 12 and one or more databases 16. The system can communicate through communications network 6. Client computers 2 can be any of a number of computing devices (e.g., Internet kiosk, personal digital assistant, cell phone, gaming device, desktop computer, laptop computer, handheld computer, interactive TV system or combinations thereof) used to enable the activities described below. Client computer(s) 2 is also referred to herein as client(s). Input devices can be any of a number of devices such as a mouse, keyboard, touch screen, track ball and microphone. Client 2 may include a graphical user interface (GUI) 3 and a web browser 17. Optionally, client 2 may include application interface(s) and driver(s) for credit card acceptor machines 8.

According to some embodiments, server 12 includes a network communications module 22, and a web based concierge application 28. The network communications module 22 connects server 12 to the communication network 6 and enables the receipt of communications from the communication network 6 and the provision of communications to the communication network 6 bound for client 2 or other destinations. Server 12 communicates with databases such as databases 16 via network communication module 22. Server 12 may manage payment information, customer information, and concierge carrier information. According to some embodiments, self-service web based concierge application 28, presents web pages on client 2 to a customer to allow the customer to select a concierge carrier from a variety of carriers, select concierge options, enter shipment information, and make payments for selected services. Web based concierge application 28 may also gather and manage customer profile information. In the case of multiple servers, each server, such as server 12, is coupled to a communications network 6 (wireless or wired) via a network communication module 22. The communications network 6 may be the Internet, but may also be any local area network (LAN) and/or wide area network (WAN). In some embodiments, server 12 is a Web server. Alternatively, if server 12 is used within an intranet, it may be an intranet server.

In essence, server 12 is configured to manage certain aspects of virtual concierge system 10, including receiving and managing requests from the customer (associated with client 2), sending messages to client 2, sending information for display on client 2 and requesting information from client 2. In some embodiments, fewer and/or additional modules, functions or databases are included in virtual concierge system. The modules shown in virtual concierge system 100 represent functions performed in a certain embodiments.

Notwithstanding the discrete blocks in FIG. 1, the figure is intended to be a functional description of some embodiments rather than a structural description of functional elements in the embodiments. One of ordinary skill in the art will recognize that an actual implementation might have the functional elements grouped or split among various components. For example, database 16 may be part of server 12. In some embodiments, database 16 may be implemented using one or more servers whose primary function is to store customer concierge information. Moreover, one or more of the blocks in FIG. 1 may be implemented on one or more servers designed to provide the described functionality. Although the description herein refers to certain features implemented in client 102 and certain features implemented in server 12, the embodiments are not limited to such distinctions. For example, features described herein as being part of server 12 could be implemented in whole or in part in client 2, and vice versa.

The above identified modules and applications in FIG. 1 correspond to a set of instructions for performing one or more functions described herein. These modules (sets of instructions) need not be implemented as separate software programs, procedures or modules, and thus various subsets of these modules may be combined or otherwise re-arranged in various embodiments.

In practice, and as recognized by those of ordinary skill in the art, items shown separately could be combined and some items could be separated. For example, some items shown separately in FIG. 1 could be implemented on a single server and single items could be implemented by one or more servers. As another example, the databases may be separated into more granular components. The actual number of servers in the virtual concierge system and how features are allocated among them may vary from implementation to implementation.

Further, certain components and networks that are well known to those of ordinary skill in the art are not described in detail in FIG. 1 to avoid obscuring aspects of the present invention. FIG. 1 may include one or more processing units (CPU's), one or more network or other communications interfaces, memory, an operating system that includes procedures for handling various basic system services and for performing hardware dependent tasks, and one or more communication buses for interconnecting these components. The communication buses may include circuitry (sometimes called a chipset) that interconnects and controls communications between system components. Memory may include high speed random access memory and may also include non-volatile memory, such as one or more magnetic or optical disk storage devices. Memory may optionally include one or more storage devices remotely located from the CPU(s).

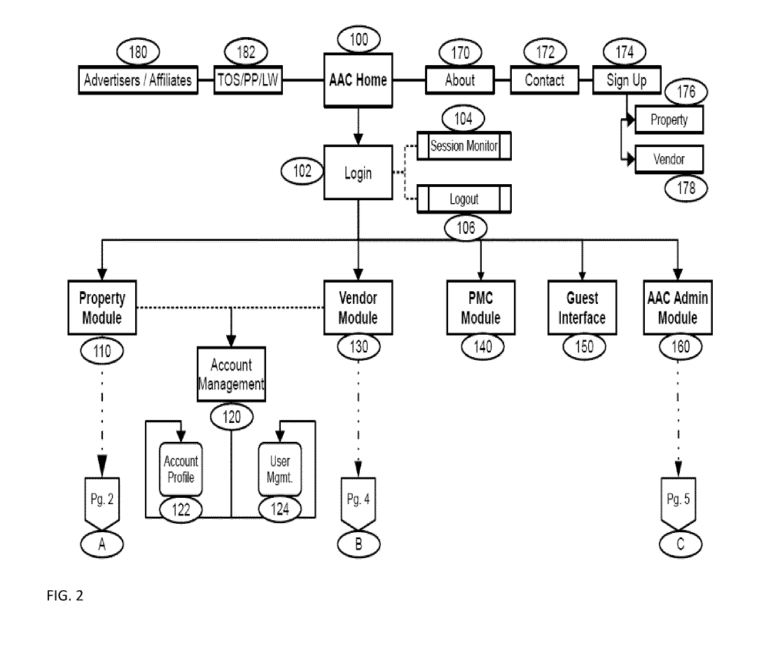

Referring now to FIG. 2, a block diagram of a concierge application called “Add-A-Concierge” (AAC) is shown. An AAC home page 100 is provided to allow users to login through a login page 102. A session monitor 104 is provided for security purposes and if a time out occurs, a log out screen 106 is shown and the user has to redo the log-in to use the system.

Upon logging-in, the user can access various modules including a property module 110, an account management module 120, a vendor module 130, a property management module 140, a guest interface module 150, and an administrative module 160. The account management module 120 stores account profiles 122 and enables a manager to perform user management module 124.

The home page 100 also provides links to an about page 170, a contact page 172, and a sign up page 174. The sign up page in turn allows a user to select a property page 176 and a vendor page 178 so that a property owner can provide information relevant to the propert(ies) to the property page 176. Similarly, a vendor can register and through the vendor page 178 can supply relevant information to the system. Additionally, advertisers and affiliates can provide information in page 180 and such information can be organized and rendered by a term of service page, a privacy page, and other functions common to web sites 182 to be rendered on the home page 100.

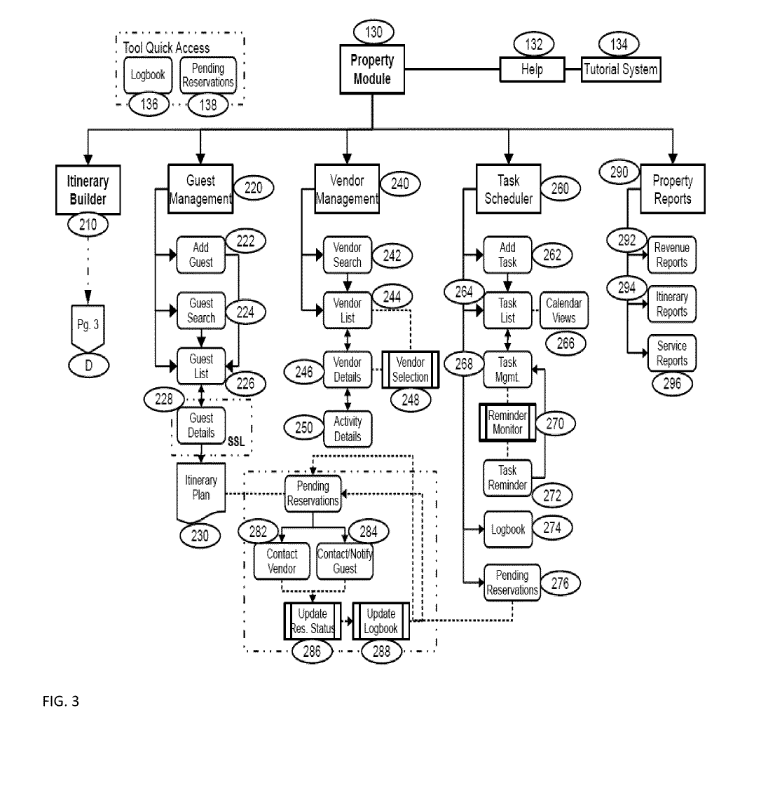

Turning now to FIG. 3, the property module 130 is detailed. The property module 130 includes a help page 132 and a tutorial page 134 on how to use the property module 130. Additionally, a logbook 136 and pending reservations 138 can be displayed in the property module 130.

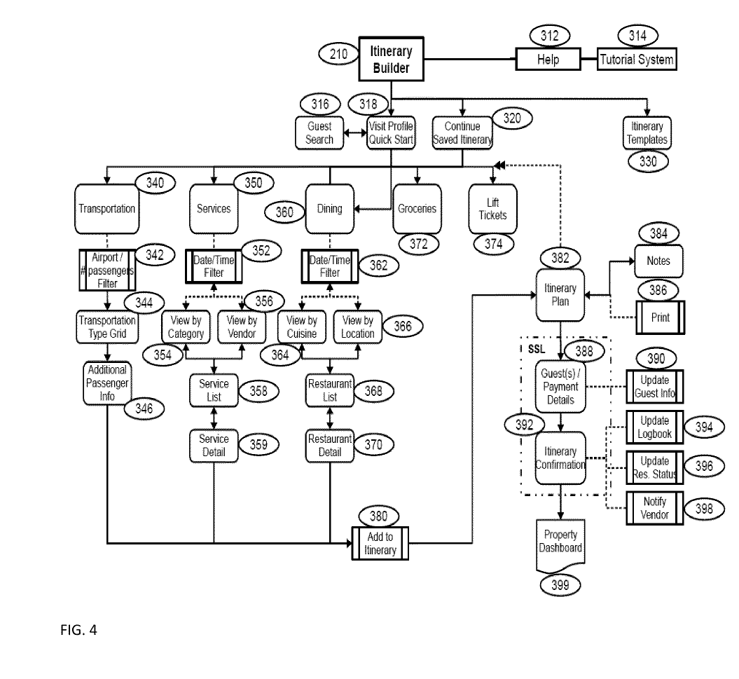

In addition, the property module 130 includes an itinerary builder 210 which is explained in more details in FIG. 4. A guest management module 220 provides an add-guest page 222, a guest search page 224, and a guest list page 226. A guest details page 228 contains sensitive information such as credit card information or social security information and thus is encrypted using a suitable standard such as SSL layer, for example. In addition, an itinerary plan page 230 captures the client's plan so that reservations can be made and subsequent reports can be generated.

The property module 130 also includes a vendor management module 240. This module provides a vendor search page 242, which returns a particular vendor matching the search term. The module also provides a vendor list page 244 which shows all vendors. The vendor list page 244 provides vendor details in page 246, and also provides a vendor selection function 248. The vendor details page 246 can show vendor activities in page 250, among others.

The property module 130 also includes a task scheduler 260, which in turn can display an add task page 262 as well as a task list page 264 linked to a calendar view 266, a log book 274 and a pending reservation page 276. The task management page 268 includes a reminder monitor 270 which is linked to a task reminder 272.

Additionally, the property module 130 includes a property reporting module 290. From this module, revenue reports 292 can be generated. Alternatively, itinerary reports 294 can be generated. Moreover, service reports 296 can also be generated.

FIG. 4 shows the itinerary builder 210 in more details. In the builder 210, a help page 312 and a tutorial system 314 is provided. A guest search function 316 allows the user to locate a particular guest. A Visit Profile Quick Start page 318 can be accessed from the builder 210. The Quick Start page 318 can be quickly generated using one or more Itinerary Template(s) 330. In place of a new itinerary, the user can select previously saved itinerary 320 to work on.

The itinerary builder 210 can handle transportation requests 340, services requests 350, dining requests 360, and other traveler amenities such as grocery requests 372 and lift ticket requests 374, for example. The grocery requests 372 can include a list of grocery items requested by the client. The lift ticket requests 374 can include types of tickets and resort names so that the appropriate tickets can be procured in advance, for example. In the transportation requests 340, the system can accept air travel requests 342, transportation type grid 344 and additional passenger information 346. Information contained in the client's profile would include, for example, preferred airlines, preferred seating (window or isle), frequent flier number (or other similar number whereby the customer gets miles, rebates for example for frequent travel or use), for example.

In one embodiment, the client profile stores credit card information (names, numbers, expiration dates etc. for each card and a default card to be used if more than one card is defined), client contact information (e.g. address, phone number, fax number, wireless device number, pager number, Short Message Service device information, e-mail address etc.), contact information for friends, relatives, acquaintances and others (e.g. name, spouse's name, address, phone number, fax number, wireless device number, pager number, Short Message Service device information, e-mail address), among others.

In one embodiment, the client profile is used to allow the operator to customize plans for the customer. With preference information having been previously stored by the system, the operator/user does not have to elicit the information from the client as the client's concierge request is being taken, thereby saving both operator and client time. In one embodiment, with a few clicks, the operator will have access to all the stored information about the client. The client can even identify in his/her personal profile information what types of information about him/her he/she would like on the operator's screen. The information is saved so that in the future, the client will not have to repeat his/her preference information, availability and the like on every call. This gives the operator the opportunity to cross sell other services on such calls by saying, for example, “would you like us to store this information for you so I don't have to ask you these questions on future calls.”

The itinerary builder 210 can also process services requests 350. Such services can be specified by a date/time filter 352. The services can be viewed by category view 354 or by vendor view 356. A complete service list 358 can be displayed, and service details 359 can be generated in one embodiment.

The builder 210 can also handle dining requests 360. A date/time filter 362 is provided to allow the user to narrow dining choices for clients. The user can access a cuisine view 364 or a location view 366 to further refine selections. A restaurant list 368 can be generated, and restaurant details 369 can be generated. Information contained in the request could include, for example, preferred types of food (e.g. Italian, Chinese), preferred restaurants, preferred restaurants for each different type of food (e.g., American food, French food, Italian food, Vietnamese food, for example), preferred restaurants by city, preferred seating (e.g. smoking or non-smoking), review requirements (e.g. the caller may be interested only in restaurants with a food rating over “20” in the Zaggat guide), preferred seating time, accepted credit card requirements, preferred number in party, preferred seating time, preferred price range, child seat requirements, among others.

From modules 346, 359 or 369, the user can add an item to the itinerary in module 380. The itinerary plan 382 is updated and notes 384 can be added. A print out 386 can be generated for mailing or review, among others. The itinerary plan can receive guest payment details 388 and since credit card data is involved, the payment details are encrypted with SSL. The guest information can be updated in 390. Once the payment details 388 are captured, an itinerary confirmation 392 can be generated. The logbook can be updated in 394, and reservation status can be updated in 396, and vendors notified about the reservations in 398. The completed itinerary can be shown on a property dashboard 399.

Although not shown, other requests can be handled. Information contained in the client's profile may include, for example, preferred movie theaters, preferred types of movies (e.g. comedies, romance, action drama, musical etc), favorite actors and other information which would allow the Concierge Provider not only to make reservations but to suggest movies the caller might like to see. Similar criteria would apply to live theater preferences. Further, information contained in the client's profile may include, for example, preferred car rental agencies (e.g. Hertz, Avis, Budget etc.), preferred car type (e.g. compact, mid-size, SUV, pick-up, transmission type etc.), preferred options (GPS system, unlimited mileage, insurance requirements, gas purchase options), frequent flier number (or other similar number whereby the customer gets miles, rebates etc. for frequent travel or use), ability to pick up and drop off at different locations, preferred price range, child seat requirements, among others.

It will be apparent to those skilled in the art having the benefit of the instant disclosure that this aspect of the present invention applies equally to many other reservation and ticket oriented domains (e.g. sporting events, trains etc.), and the scope of this invention is intended to be broad enough to cover each of these domains. Moreover, it will also be immediately apparent which preferences make sense for each type of domain (e.g. preferred carrier would apply to trains, frequent flier numbers would apply to airlines, personal preferences, birthdays, beverages, cuisine types, for example).

FIG. 5 shows an exemplary vendor module 130. The vendor module 130 includes a vendor profile 420. Vendor details 422 can be generated and the information can be viewed live in 424. The vendor module 130 includes a service management module 430. The module includes an add service 432 and a service list 434. Service details 436 can be pulled from the service list 434, and a live view 438 can be generated. The module 130 also includes a reservation management module 440. In the reservation management module 440, a status filter 442 is provided to help users locate reservations with particular issues. For example, the status type can include cancelled reservation type 444, denied reservation type 446, new reservation type 450, pending reservation type 452, and confirmed reservation type 454, among others. Reservation details 448 are available for each type. Additionally, the reservations can be processed in 458, and the logbook updated in 460, the reservation status updated in 462, and the property is notified in 464. The vendor module 130 also includes a specials and packages module 470, which provides information on special deals or packaged deals that provide savings for clients if the details of the deals or the packages are acceptable to the clients. Also, the module 130 includes a vendor reporting module 480 to generate various management reports on the vendors.

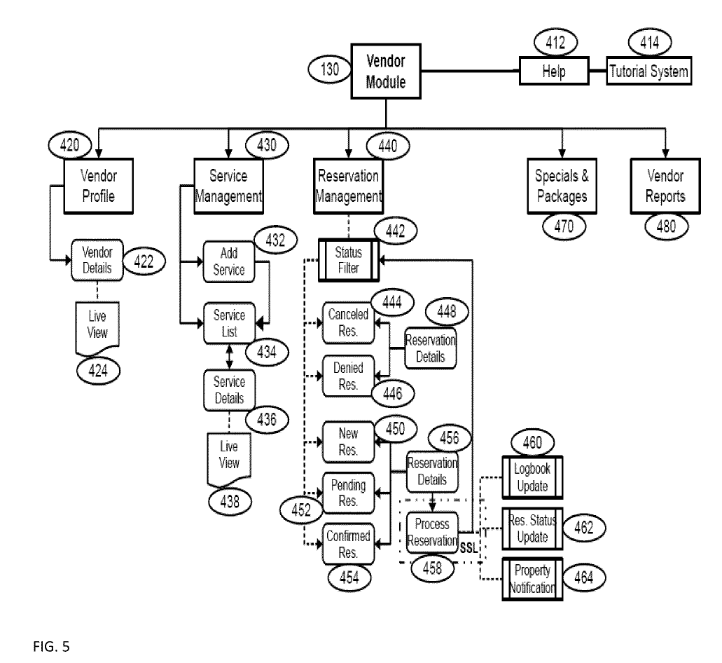

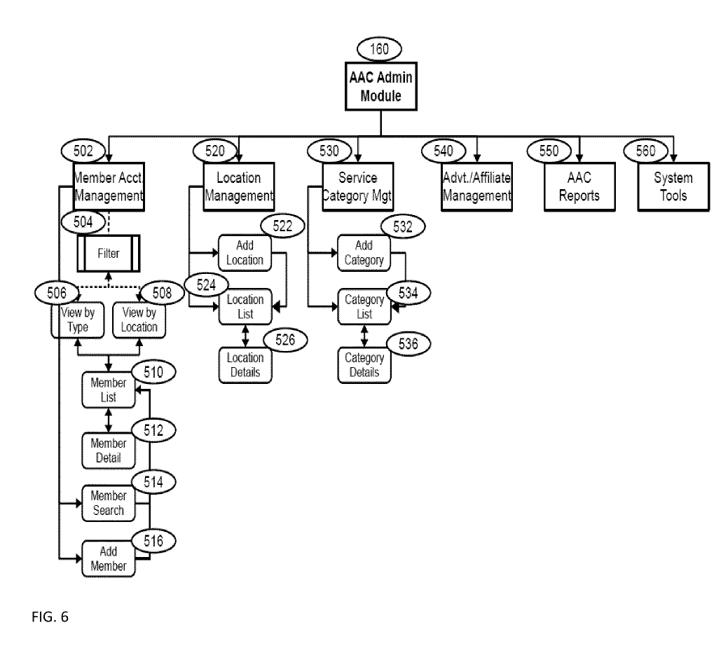

Referring now to FIG. 6, an administration module 160 is shown. The administration module includes a member account management module 502, which includes a filter 504 to support a view by type 506 or view by location 508. The module 502 can generate a member list 510 showing member details 512. A member search function 514 is provided to locate a particular member, and a new member module 516 allows new people to be added to the system.

The module 160 also includes a location management module 520, which supports an add location function 522. The location management module 520 also includes a location list 524, which provides location details 526 on demand.

A service category management module 530 is provided. An add category function 532 is supported, as is a category list 534 which allow category details 536 to be shown. Similarly, an advertiser/affiliate management module 540, a reporting module 550 and a system tools module 560 are provided to manage the system.

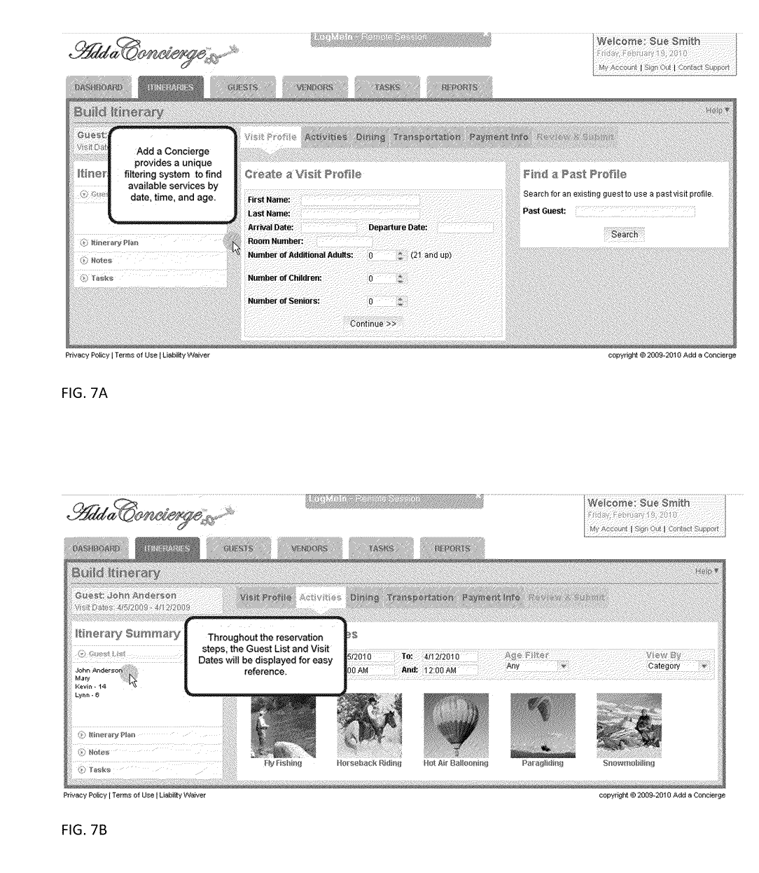

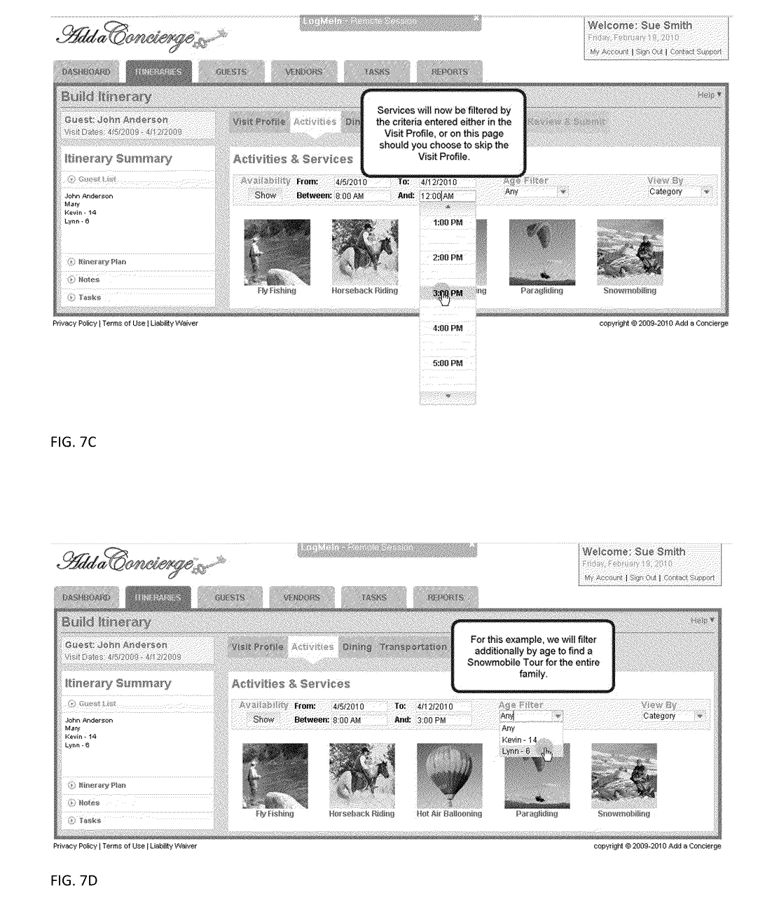

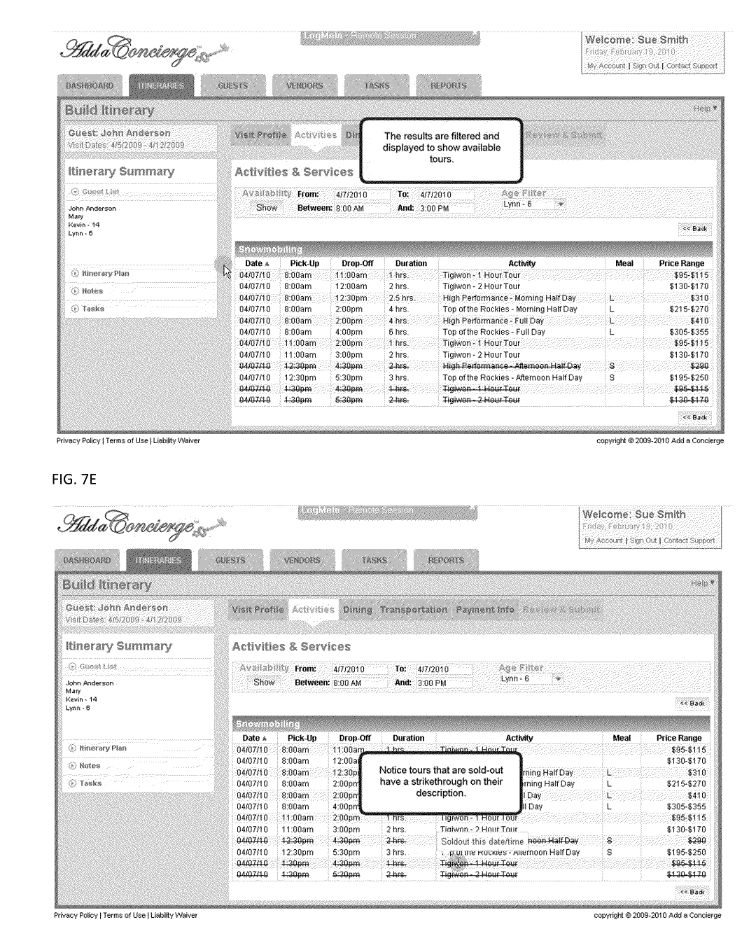

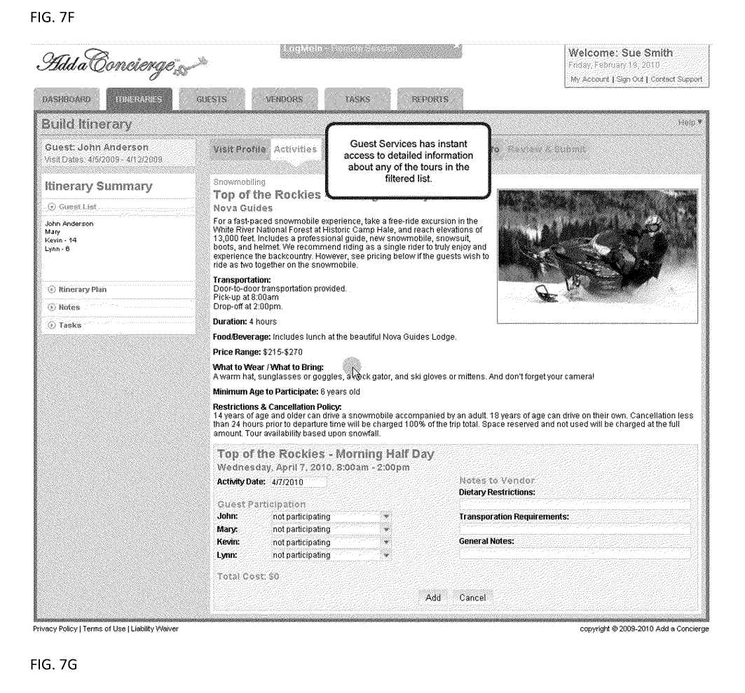

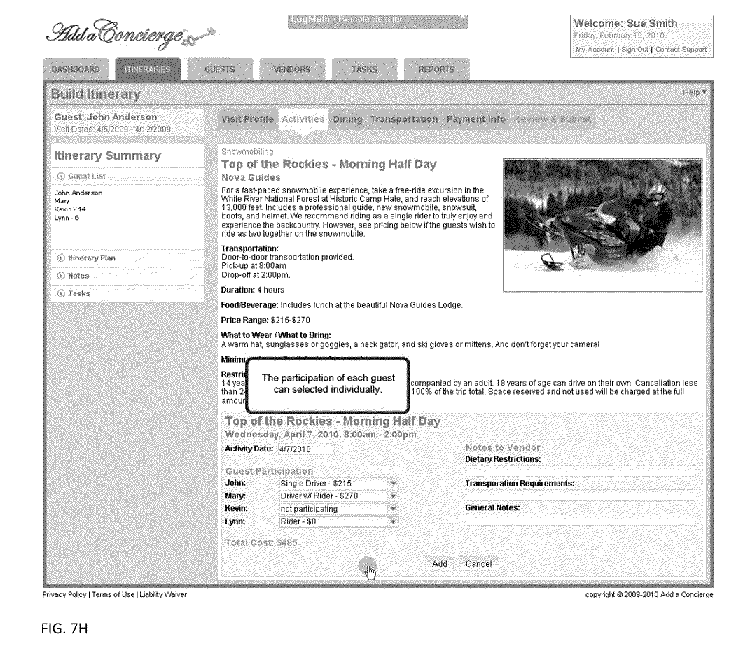

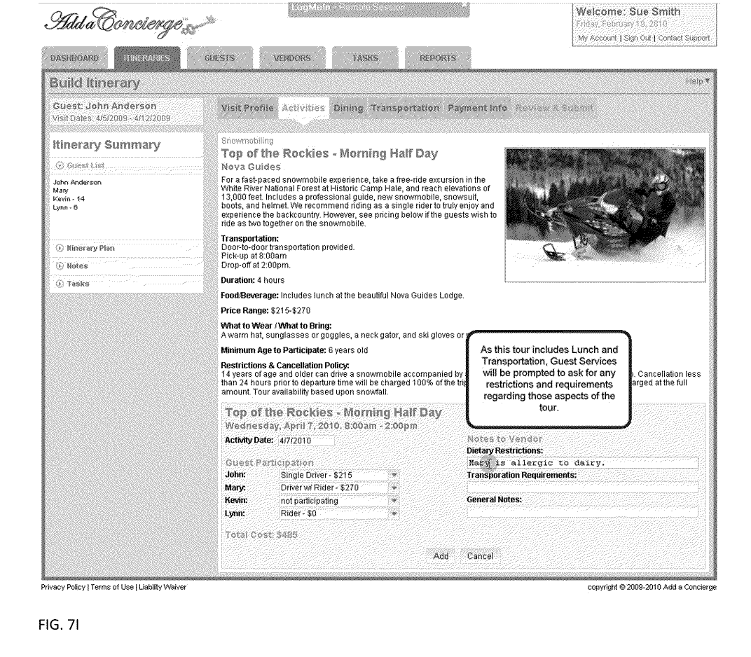

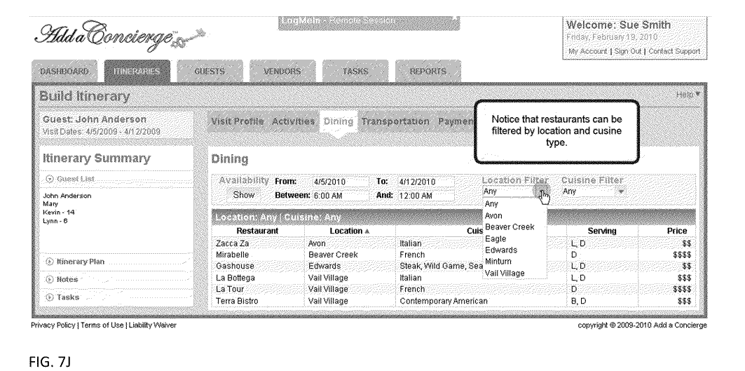

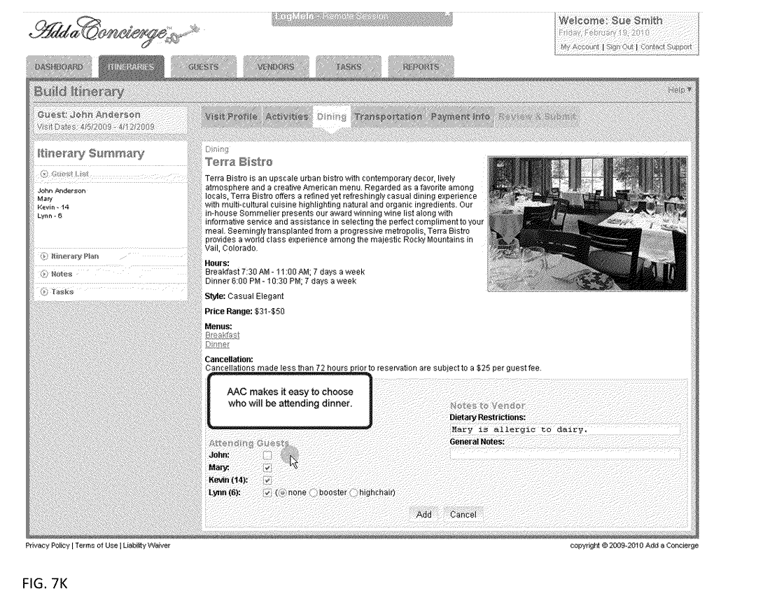

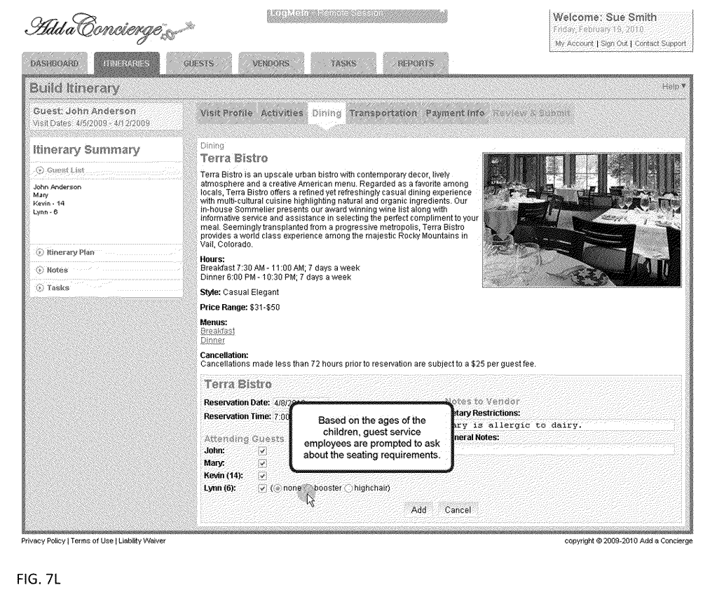

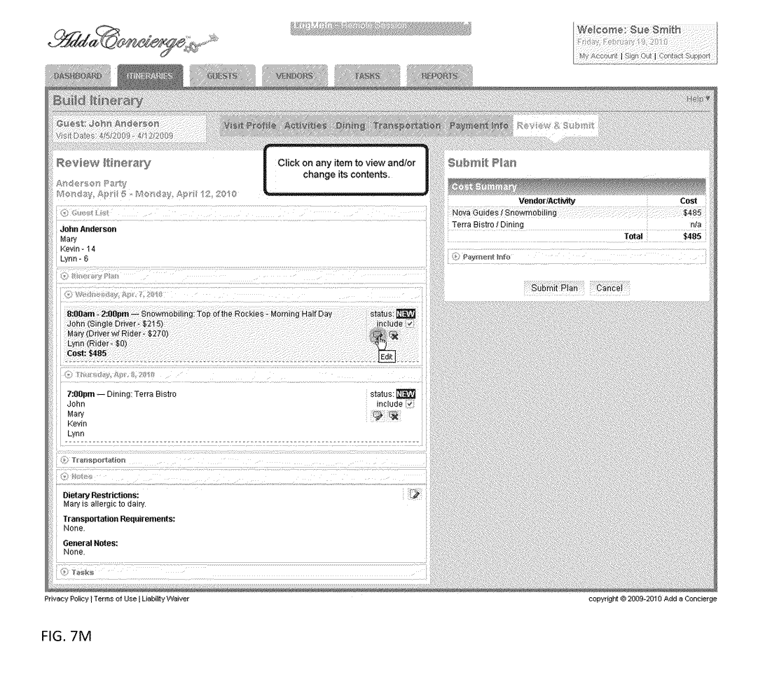

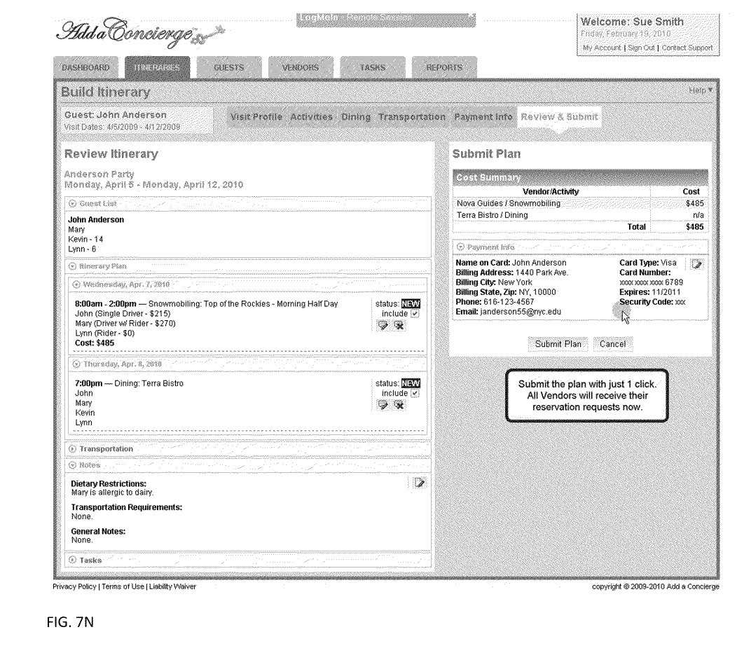

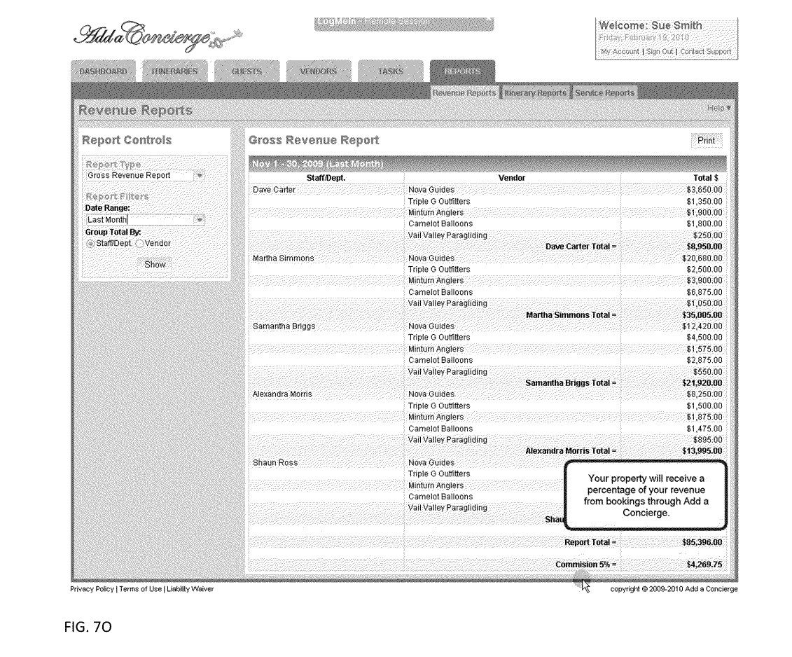

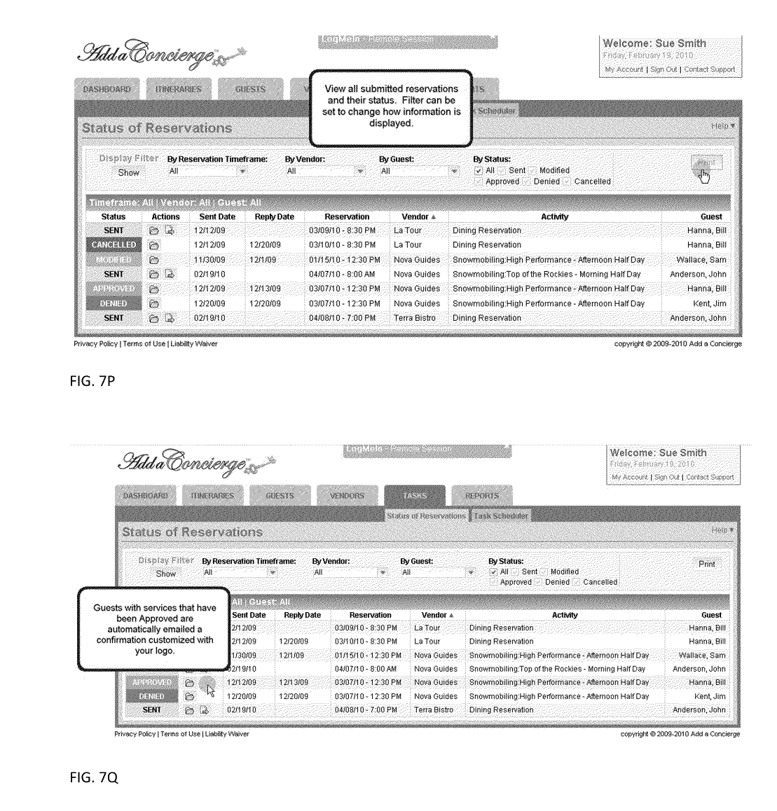

FIGS. 7A-7Q show exemplary user interfaces for the concierge system. As shown in combination therein, the system administrator can specify Access Levels & Types, for example: Master, Administrator, Property Manager, Property Staff, Vendor Manager, and Vendor Staff. The Session Monitoring can require a Login: username, password for each user (primary account, general staff account). In one embodiment, the session monitoring includes allowing no more than a predetermined number of sessions per login account, as well as a session timeout. A forgot password functionality is provided to help authorized users to regain access. In the User Account Management, an exemplary Account Profile includes information that a primary account holder can manage contact name, phone number, email, address, username, and password. For each general user account, the primary account holder can manage name/department, username, and password.

In the Property Dashboard, a number of user interface elements are used. Exemplary elements include: Button: itinerary builder; Form: guest search; List: recent/saved itineraries; List: pending reservations; and List: tasks for current user.

The Guest Management tab defaults to the Guest List screen; includes Add Guest button and Guest Search form. In the Add Guest module, the user can enter name and contact info, credit card data (requires SSL connection). The module can verify that the guest is not a current guest and record date/time added (date/time stamp). After adding the guest, the system returns to the Property Dashboard. In the Guest Search module, the system can search by last name or email address and returns a list of records matching last name or email address. In the Guest List module, the system can list guests alphabetically by last name; sort list by last name, visit date, or email; perform pagination for long lists. The user can click on guest name to open Guest Detail screen. Icons/colors indicate reservation status.

In the Guest Detail Screen, one embodiment of the system supports the ability to: view guest contact information; open form to edit contact information; securely view credit card information; open current (or past) itinerary in Itinerary Builder tab. The user can click on the Save and Cancel buttons to return to Guest List page.

Vendor Management tab defaults to the Vendor List screen; includes Vendor Search form. The Vendor Search function includes a Search by name feature, which returns list of records matching name. In the Vendor List, the system can list vendors alphabetically by name; sort list by name or service category; perform pagination for long lists. The user can click on vendor name to open Vendor Detail screen. The user can toggle “preferred vendor” status via a checkbox column in the list. In one implementation, when a new vendor is added to the AAC system by the administrator, that vendor will default to a “preferred” status for all properties In the GUI, the Vendor Detail Screen supports the ability to view vendor information; list services provided by vendor. The user can click on a service name to view service details. The user can toggle “preferred vendor” status, and after viewing details, the user can go back to vendor list.

In the Task Scheduler, a Task Scheduler Dashboard includes: a task list for current user and pending reservations. An Add Task UI allows the user to create task with following info: assigned to, guest name, due date/time. Certain fields can be\automatically stored with the task: assigned by, assigned on (date/time stamp). After adding a task, user is taken to the task list screen. In the Task List, the user can list all “open’ tasks ordered by due date, oldest to newest; sort list by due date, assigned to, or guest name. The user can also toggle “complete” status via a checkbox column in the list and click on task item to open Task Detail screen.

In the Task Detail Screen, the user can open task details in a form that allows editing of information. From form, user can Cancel, Save, or “Save and Mark as Complete”. After canceling or saving, user is returned to task list.

In the Pending Reservations, the reservation status indicators for property include pending new indicator (yellow) indicating the reservation has not been processed by vendor; vendor has not responded with confirmation, alternative, or denial and a pending modified indicator (orange) indicating the vendor has modified request and is awaiting a reply from the property. The system lists only reservations that are pending (new or modified); confirmed and denied reservations are not shown. The system can show service type, vendor name, guest name, reservation date/time, request sent date/time, sort list by any column. Clicking on the guest name takes user to guest's Itinerary Plan of which the reservation is part of, and clicking on vendor name reveals contact name, phone, and email.

The Property Reports access is limited by level of user (manager vs. staff), and the Property Reports Dashboard includes a “Snapshot” of key data and links to primary reports. The Visit Profile Quick-Start collects minimal information: guest name, arrival date, departure date, additional guests in groupname, age, relationship. A search form allows user to search for guest. If guest is a previous guest, then user can select the guest and prior group to pre-fill quick-start form. A Continue Saved Itinerary function provides a list of itineraries that have been saved but not finalized. The list shows guest name, date itinerary was started, and clicking on guest name in list will open itinerary in main Itinerary Builder screen.

In the Transportation page, the user selects airport and enters number of passengers and date. A list of transportation options is shown based on the airport and number of passengers, and the list can be grouped by shuttle, car, and private; ordered by price within groups.

In the Services page, available services can be filtered by desired date and time range. Services/vendors that are not available based on date/time range filter will be grayed out, but will still be selectable for review of information. Services can be viewed as grouped by category or by vendor. Only vendors that are marked as “preferred” by the property are shown in one embodiment, but in other embodiments, the preferred vendors are shown first. Selecting a category displays a list of services available within the date/time range. The list shows date, time, duration, vendor, and price range. Clicking on a service item opens the service detail screen for the selected service. The service detail screen includes data about the service such as description, photo, vendor URL, general price range, duration, restrictions, cancellation policy, transportation notes, notes on what to wear and what to bring. The system displays in one embodiment: dropdown list of available dates within guests stay range; dropdown list of available times of service; dropdown list for each guest in group that allows selection of service price options; text box to enter notes to the vendor regarding the guests; a price total that automatically updates as guest selections are made; a cancel button take user back to previous service list; and an add button saves the service to the guest's itinerary and returns to the initial service screen.

In the Dining page, available dining options can be filtered by desired date and time range. Restaurants that are not available based on date/time range filter will be grayed out, but will still be selectable for review of information. Restaurants can be viewed as grouped by cuisine or by location, and restaurants that are marked as “preferred” by the property are shown first in one embodiment while in other embodiments, only preferred restaurants and vendors are shown. The restaurant list shows restaurant name, address, phone, and general price range. Clicking on a restaurant opens the restaurant detail screen, and the restaurant detail screen includes data about the restaurant such as description, photo, restaurant URL, general price range, cancellation policy, etc. A dropdown list of available dates within guests stay range. A dropdown list is shown for available times for the reservation. The system also provides a checkbox for each guest in group that allows selection of attendance, a text box to enter notes to the restaurant regarding the guests; a cancel button takes user back to previous restaurant list; and an add button saves the restaurant reservation to the guest's itinerary and returns to the initial dining screen.

In the Guest & Payment Details, the connection is a secure SSL connection. The user can enter or verify additional contact information. Contact info may be filled in if guest was a previous guest. The user can enter credit card information, and after saving the system continues to Itinerary Plan Confirmation

In the Itinerary Plan Confirmation, payment details must be entered before itinerary can be confirmed. The itinerary plan shown with all transportation, services, and dining reservations; date/time, participants, and total cost for each is shown. Service items can be included/excluded with a checkbox. Only checked items will be communicated with vendors for reservation confirmation purposes. Unchecked items will be saved but not reserved. Once an item is sent to a vendor for reservation, it cannot be unchecked, but can be canceled. The total cost shown at bottom; based only on the included (checked) items, and the plan can be printed.

In one implementation, the reservation status of each service is indicated by a colored icon:
no color—not included
blue—included in plan but not yet sent to vendor for reservation
yellow—sent to vendor for reservation but vendor has not responded
orange—vendor replied with alternative reservation options; not approved, not denied
green—approved by vendor
red—denied by vendor
gray—canceled (by vendor or guest)

The Vendor Dashboard provides the following Button: Add service; List: Services; New reservations; and List: Pending reservations. For the Vendor Profile, the user can view and edit vendor profile information: vendor name, contact name, description, logo, address, phone, general email, reservation email. A “Live view” link to view how profile information appears to user in AAC site. After Save or Cancel, the system returns to the Vendor Dashboard

The Service Management tab defaults to the Service List screen and includes an Add Service button.

In the Add Service: Activity Vendor page, the user can enter service name, description, and photo; select service category; enter available date range; enter start time and duration; eEnter note for “what to wear/what to bring” and transportation; enter Restrictions and Cancellation Policy; enter general price range; enter price options; add multiple options: name/price; or enter extra fees cost. In the Add Service: Restaurant Vendor page, the user can select; service name, description, and photo; available date range; available time range; or general price range. In the Service List, the system lists services alphabetically and shows service name, date range, time. A “Live view” link allows users to view how service information appears to user in AAC site. The user can click a service name to open a Service Detail screen. The Service Detail Screen allows a user to view all service details; open form to edit service details; or click on the Save and Cancel buttons to return user to Service List.

Under the Reservation Management page, the system provides a reservation status indicators for vendor:
pending new (blue)—have not been processed; vendor has not responded with confirmation, alternative, or denial
pending modified (orange)—vendor has modified request and is awaiting a reply from property
confirmed (green)—confirmed and all details finalized
denied (red)—vendor denied reservation and did not provide alternatives
canceled (gray)—cancellation by property/guest or by vendor

By default, the system lists all new and pending reservations ordered by received date; new and pending are distinguished by colors and/or icons. “Past” reservations, those with a reservation date older than the current date, will not be listed. An option to view past reservations will be provided. The list can be filtered by status level; selected by dropdown. The list displays property name, guest name, service name, reservation date, and reservation time. The list can be sorted by property name, guest name, service name, or reservation date. Clicking on a reservation item opens the Reservation Detail screen

The Reservation Detail Screen displays service name, reservation date, reservation time, primary guest name, participant names with selected service price option, property/guest notes, total cost. The screen also displays options for New and Pending reservations: Accept Reservation, Deny Reservation, or Alternative Reservation. The system can process options for Confirmed reservations: Cancel Reservation. For Canceled and Denied reservations, the reservation can only be viewed; no additional processing is possible. The following Reservation Options are handled:
Accept Reservation option where credit card information is provided to the vendor; the reservation status is changed to Confirmed. The system notifies property and/or guest, and the vendor can add note to notification message
Deny Reservation option where the system updates reservation status to Denied and notifies property and/or guest
Alternative Reservation option where the system keeps reservation status at Pending and notifies property and/or guest. The vendor can add note to notification message to provide alternative dates/time or other options
Cancel Reservation option where the system updates the reservation status to Canceled and notifies the property and/or guest

In the Administration Module, the user can select Add Member page to: select member type: property, service, restaurant, or transportation; select location; enter business name and contact information; enter commission rate and type (flat or percent); or send account activation information and link to new member. Activation process allows new member to verify information, review and accept policies and waivers, and set username and password for account login.

A user can perform Member Search to search by business name, contact name, email address, or username. The system returns a list of matching records.

The user can also review a Member List page which lists members alphabetically by business name. The system can filter list by vendor type or by location; list shows business name, contact name, phone, email, username, and activation date; sort list by business name, contact name, username, or activation date; perform pagination for long lists. Clicking on the business name opens Member Detail screen. In the Member Detail Screen, the user can view information. For vendors, the user can view services with price options and fees. The user can modify commission rate and type (flat or percent).

The user can perform Location Management. New locations can be added through an Add Location page: enter location name and state; select airports serviced by location; add new airport (name and code); select service categories. After adding the new location, the system returns to Location List screen

The user can also view a Location List, which lists all locations, sorted alphabetically. The page shows location name and state. Clicking on the location name opens the Location Detail screen, which in turns opens form with location information and allows editing of location name, state, airports, and categories.

The user can perform Service Category Management. To Add Category, the user can enter category name, enter category description, and upload thumbnail image/icon. After add, the system returns to a Category List screen. In the Category List screen, the system lists all categories, showing name and image/icon. Clicking on the category name opens the Category Detail screen. The Category Detail Screen opens form with category information and allows editing of category name, description, and image/icon.

It is to be noted some of the data fields in the web pages describes above may be optional. Further, the concierge service options and payment options may vary depending on the concierge carrier selected and depending on the business objectives of the business concern that is using the virtual concierge system. Thus the design of graphical user interface of FIGS. 7A-7Q and the web pages described above may vary from implementation to implementation.

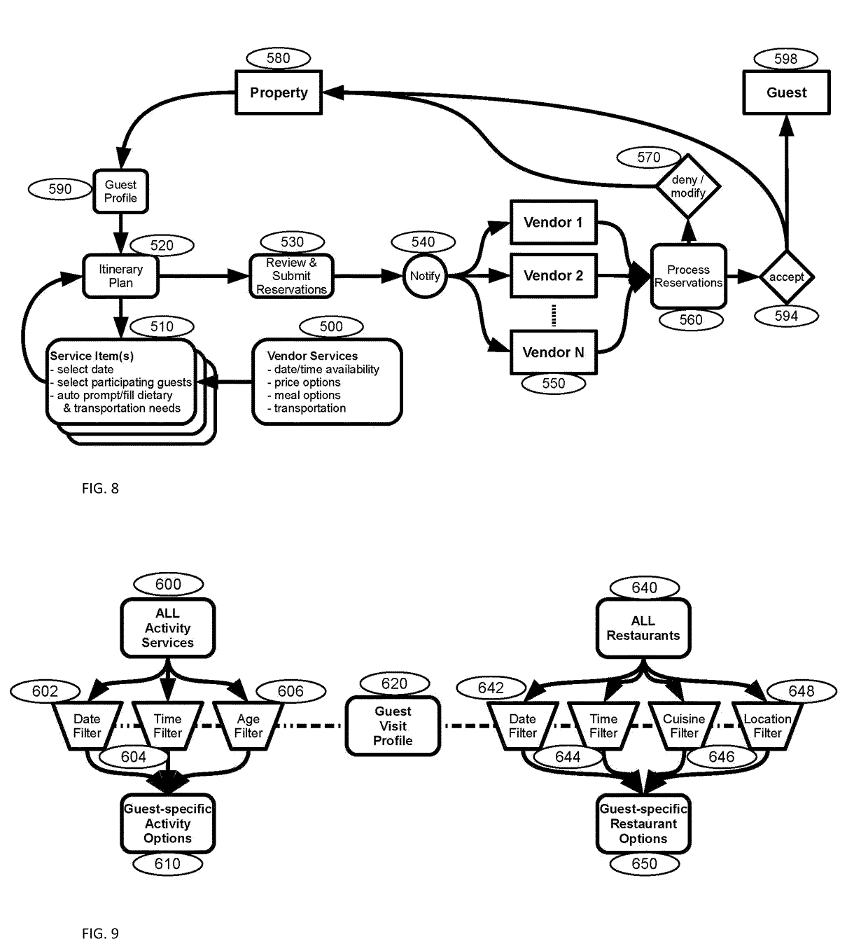

FIG. 8 shows an exemplary reservation process. The process obtains from a database services and/or products available from one or more vendors (500). Exemplary data associated from each service can include date/time availability of services, pricing, meal options, and/or transportation to the site where the services are served, for example.

Once the vendor data is obtained, the process prompts the user to select a desired service (510). The user can enter date, guest names, menu choices, and transportation needs, for example. In one embodiment, the system automatically fills in the food and transportation needs based on the previously created guest profiles (590) by the property (580). For example, the dietary requirements can be used to prompt the user to select specific food items or to select a preferred transportation mode. Next, an itinerary plan is created (520) based in part from the guest profiles (590). The plan is reviewed and submitted to vendors for reservations (530). The vendors are notified via email, instant messaging, or any suitable methods including fax (550). The vendors process the reservations (560) and can accept (594) or deny/modify (570) the reservations. A message is then sent to the property (580) and communications about the reservation can be sent to each guest to update the guest of the status of the trip.

The user clicks on the “Review and Submit” Tab to see on one screen all information entered for that guest's itinerary. Should the user leave the status of each service/dining reservation request as is, all requests will be submitted to each vendor. Alternatively, should the user choose to change the status of any service/dining request, the user can simply click on one of three options:

1) “Include checkbox”: By clicking on this check box, the user can choose to not include the reservation request at the present time. All other requests will be submitted to the appropriate vendor/restaurant. Only those that are unchecked will be excluded from submission.

2) “Edit” icon will return the user to the specific page where the original reservation request was developed. There the user can continue to make edits and click the “Add” button to save the new information. By then clicking the “Review and Submit” Tab, the user can continue with submitting the service/restaurant requests.

3) “Delete” icon will delete that specific service/dining request and it will no longer be saved to the Guest's Itinerary.

In one embodiment, for each service booked by the hotel through the system, the hospitality company or owner will receive a commission from the vendor. The system can share a portion of each commission received with the hotel on a monthly basis. The system provides to Executive Level Hotel Management a real-time Gross Revenue Report which reports the revenue of services booked for each vendor by each user password. At the bottom of the report is the total amount of revenue share earned by the hotel for the date range requested by the hotel under the Report Controls, offered on the left side of the report screen.

FIG. 9 shows an exemplary available service or product filtering process. The process starts by showing all activities and services (600). A plurality of filters are provided to allow users to narrow down options. The filters can be done automatically using guest visit profiles 620. For example, activity filter 600 can be provided to show only relevant activities, or restaurant filter 640 can be used to narrow down breakfast/lunch/dining choices.

For example, a date filter can be used to restrict the date range (602), or a time filter can be used to restrict activities to a certain time period (604), or an age filter can be used to funnel activities that are appropriate for particular ages (606). For example, children cannot participate in strenuous or activities requiring a minimum height and thus such activities typically have an age restriction. The foregoing filters are not exhaustive in nature, but are illustrative in purpose only. Based on the filter settings, which can be individual or aggregate, the system filters out non-matching activities and displays only guest-specific activity options so that the user reviews only relevant activities (610).

Referring now to food filters, the system starts with all restaurants as candidates (640). The date filter can be used to restrict the date range (642), or a time filter can be used to restrict eating choices to a certain time period (644), a cuisine filter can be used to select food type such as Italian or steak houses or vegetarian restaurants (646), and a location filter can be used to select restaurants that are nearby or in a particular city (648), for example. Based on the filter settings, which can be individual or aggregate, the system filters out non-matching activities and displays only guest-specific activity options so that the user reviews only relevant restaurant choices (650).

The foregoing system is convenient to use. The system provides is a cost-effective Web based system that enables hospitality companies and hotels to deliver superior service to guests without having to overstaff. By enabling regular employees to substitute for expert concierge, the system empowers any hospitality organization with the ability to right-staff. All information is available with a few clicks. The system guides the user to offer guests with the right experience by filtering options to relevant choices. Once the guest selects his/her choices, at the click, all selected vendors are electronically contacted at once, thus saving the hotel employees of the need to individually and manually contact each vendor and make individual reservations over the phone. Hospitality companies can also take advantage of the solution to cross-sell and up-sell their services by monitoring the information that guests receive. If a guest is interested in having seafood for dinner, for example, the system can show hotel employees and guest photos, descriptions, and menu prices of the seafood dishes available at the hotel's restaurant. The system combines the benefits of face-to-face customer relationships with the most current information available. The solution helps to deliver an unparalleled level of service in a cost-effective, innovative solution. The system enhances the relationships hospitality operators build with guests—and those relationships are built on superior service.

Other advantages of the preferred embodiment may include one or more of the following. The system automates the communications between the guest service employees, the vendors and restaurants, and the guests. In one embodiment, the automation saves at least 30% of the employee's time with each guest itinerary, allowing employees to service a greater number of guests comprehensively, efficiently, and ethically. The system brings to the forefront the hotel's high priority of providing the guest the best experience possible based on the services that each vendor provides, and taking in to account their reliability, integrity, and what they offer to the guest as part of a memorable destination experience. The system accomplishes this by allowing the vendor to have their own secure interface in to the system to accurately input the details of their services. In turn, hotel management has control over the vendors that appear on their system. For example, if a vendor is in a region with a certain number of hotels that use this system, and one hotel does not want to use that particular vendor, the system allows that vendor to be blocked from that one hotel, while still appearing in the remaining hotels. The system uniquely allows ANY employee of any hotel in any region to easily use the system as it is designed with clean, intuitive, easy to use screens—without any need to add redundant guest information. The business model of the system brings ethical and uniformed commissions paid by the vendors only for services booked to the company. This eliminates vendors having to bribe guest service employees with higher commissions than their competitors pay. The company shares with the hotel a portion of the commission paid for each service, thus generating a revenue flow for a department which a hotel rarely receives. The concierge system performs tasks that save time and money. They organize and schedule and resolve the problems that continue to exist in the industry. The software reduces the need on the hotel employee to enter all of the information and thus is efficient and not reliant on employees' efforts to keep them up to date. This system takes any destination location and consolidates all the services, accurately input by the vendors themselves in real-time, available to the guest so any hotel employee can become a trained concierge ready to serve guests and clientele. The system can also prompt the hotel employee to collect information from the guests if the vendor requests. This can be very important when it comes to collecting information on food allergies, ages of children, and ability levels of participating guests.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various embodiments with various modifications as are suited to the particular use contemplated.

What is claimed is:

1. A computer implemented method to provide concierge services for a hospitality company, comprising:
a. receiving an itinerary having one or more guest interests indicated therein, wherein each interest has different combinations of guests from a group, as not every guest wants to participate in every service that is booked;
b. receiving one or more vendor capabilities from a vendor database, as each vendor can login and control their own detailed content including descriptions, times, menus, minimum ages, cancellation policies, and required experience levels;
c. matching the guest interests with the vendor capabilities;
d. after verbally or in writing confirming guest interests, clicking a submit button to send communications to a plurality of vendors instantly through an internal email notification system;
e. receiving separate vendor confirmation for each guest interest combined on one chronological itinerary, including details for contact, what to bring and wear, service descriptions, times, minimum ages, cancellation policies; and
f. communicating vendor confirmation with the hospitality company guest service employee to follow up with the guest and saving a history of guest activities to assist guests efficiently on another visit.

2. The method of claim 1, comprising
a. sending an email or instant messaging to the vendor to notify the vendor of a communication on a reservation request, wherein the vendor securely logs in to the system, and views the reservation request which include information to make the reservation; and
b. prompting the hospitality company guest service employee to request information from the guest that the vendor requires.

3. The method of claim 1, comprising receiving a confirmation or an update from the vendor on a predetermined guest interest.

4. The method of claim 3, comprising notifying the hospitality company of the vendor update with an email.

5. The method of claim 1, comprising notifying the guest of trip status in an email or on-line message.

6. The method of claim 1, comprising providing a filter showing guest specific activity options or restaurant options and updating the filter based on guest preferences including date, time, and age, and find applicable activities, restaurants, and services that fit one or more filter criteria.

7. The method of claim 1, comprising providing a filter for date, time, age, or location.

8. The method of claim 1, comprising automatically generating recommended meal plan based on a dietary profile or a local transportation for the guest interest based on a guest profile.

9. The method of claim 1, comprising determining shared revenue due the hospitality company based on a reservation and generating in real time reports.

10. The method of claim 1, wherein the vendor or an employee of the hospitality company logs into a secured server to access all information relating to a guest activity.

11. A computer implemented method to provide concierge services for a hospitality company, comprising:
a. receiving an itinerary having one or more guest interests indicated therein;
b. receiving one or more vendor capabilities;
c. filtering candidate trips by matching the guest interests with the vendor capabilities; and
d. displaying the filtered candidate trips at the hospitality company for selection and review by the hospitality company with the guest(s).

12. The method of claim 11, comprising:
a. receiving an itinerary having one or more guest interests indicated therein;
b. receiving one or more vendor capabilities;
c. matching the guest interests with the vendor capabilities;
d. communicating the guest interests with to vendors matching the interests in one simultaneous communication;
e. receiving vendor confirmations for each guest interest; and
f. communicating vendor confirmation with the hospitality company.

13. The method of claim 11, comprising providing a filter showing guest specific activity options or restaurant options.

14. The method of claim 11, comprising providing a filter for date, time, age, or location.

15. The method of claim 11, comprising automatically generating recommended meal plan based on a dietary profile or a local transportation for the guest interest based on a guest profile

16. The method of claim 11, comprising determining shared revenue due the hospitality company based on a reservation.

17. The method of claim 1, wherein the vendor or an employee of the hospitality company logs into a secured server to access all information relating to a guest activity.

18. The method of claim 17, comprising receiving a confirmation or an update from the vendor on a predetermined guest interest for a predetermined reservation.

19. A computer implemented concierge system for a hospitality company, comprising:
a. means for receiving an itinerary having one or more guest interests indicated therein;
b. means for receiving one or more vendor capabilities from a vendor database;
c. means for filtering candidate trips by matching the guest interests with the vendor capabilities; and displaying the filtered candidate trips for selection;
d. means for matching the guest interests with the vendor capabilities;
e. means for communicating the guest interests in one substantially parallel transmission to all vendors matching the interests;
f. means for receiving separate vendor confirmation for each guest interest; and
g. means for communicating vendor confirmation with the hospitality company.

20. The system of claim 20, comprising means for sharing revenue from a reservation with the hospitality company.

21. The system of claim 20, comprising means for determining commissions owed to the system for each service booked by the hospitality company.

22. The system of claim 20, comprising means for sharing visit profile information with each selected service.

23. The system of claim 20, comprising means for generating auto-confirmations so when the vendor confirms an activity, the hospitality company employee is notified and the itinerary is automatically emailed to a guest.

24. The system of claim 20, comprising a filter for hiding sold-out services.

25. The system of claim 20, comprising:
a. means for revenue Sharing between a network operator and members of the network including the hospitality company;
b. means for displaying a status of reservation in different filterable configurations showing requested, modified, approved, canceled, or denied requests to allow the user to monitor, in real time, the status of all reservation; means for taking reservation request(s) entered into the itinerary by a guest service employee and contacting the vendors through email for request confirmations;
c. means for prompting the guest service employee to ask questions that pertain to information needed for a particular service which prevents the guest service employee from having to remember (or be trained) what questions to ask, and when, in order to complete a reservation request;
d. means for capturing visit profile information that carries over into each service selected; means for providing a vendor interface where vendors can login and enter/edit/view their service descriptions or view/confirm/deny/modify reservation requests;
e. means for generating auto-confirmations when the vendor confirms an activity to notify the guest service employee and the itinerary is automatically emailed to the guest; and
f. means for indicating sold-out services after filtering.
